(19) United States
(12) Patent Application Publication
(10) Pub. No.: US 2003/0003871 A1
(43) Pub. Date: Jan. 2, 2003

(54) Wearable wireless cap phone

(76) Inventor: Charles L. Urso, Waltham, MA (US)

Correspondence Address: Charles L. Urso, 54 Marivista Avenue, Waltham, MA, 02454-1136, US

(21) Appl. No.: 09/892,976

(22) Filed: Jun. 27, 2001

(51) Int. Cl. H04B 7/00

(52) U.S. Cl. 455/66; 455/556; 455/569

(57) ABSTRACT

A cap phone (10) includes a wireless telephone (29) incorporated in a soft cap (12). Within the cap (12), a housing (30) that holds telephone electronics and a battery (32) is supported under a crown (14) by arcuate ribs (44, 48). Movably supported by a rib (44) and wired to the electronics is a retractable earphone (52) and a retractable microphone arm (61) attached to a microphone (60). Also wired to the electronics is a telephone keyboard (34) and an LCD display screen (36) mounted to a cap visor (24). In another preferred embodiment, a microphone (78) is mounted under a cap visor (79) and an earpiece (75) is detachably mounted to the visor (79).

### BACKGROUND

1. Field of Invention

This invention relates to wireless telephones, and more particularly to wireless telephones incorporated in head garments.

2. General

Talking on a hand-held wireless telephone prevents the user from simultaneously doing other activities. Hence, valuable time is lost. By comparison, talking on a hands-free wireless telephone gives the user the freedom to prepare dinner, do household chores, work in the garden, work out at the gym, go jogging, and so on. Though hands-free wireless phones are available, they comprise individual components, including a headset, that need to be connected by a cord. Those that are available, therefore, are inconvenient to use. More importantly, they are displeasing in appearance. Users feel self-conscious and unattractive wearing them; especially in public. Very few people will allow themselves to be seen wearing a hands-free phone when walking, shopping, or at the fitness club. As result, existing models on the market are not popular, despite the practical advantages.

The present invention provides a solution. A wireless telephone is discretely hidden and operable in a baseball-style cap and the combination is wearable. Modern baseball-style caps are aesthetically pleasing in appearance and are being worn by both sexes of all ages. Therefore, a phone that appears to be a baseball cap can overcome the consumer resistance toward hands-free telephones currently on the market.

### SUMMARY

The present invention comprises a baseball-style cap having a soft crown and a stiff visor attached to the crown wherein the visor includes a concave underside. First and second stiff arcuate ribs form upstanding arches under the crown. The second rib includes an end portion fixedly and rigidly connected to the visor wherein the ribs are transverse to each other. A wireless telephone is supported by the cap such that a user can communicate, hands-free, while wearing the cap. The cap crown includes a circumferential edge wherein an earphone, pivotally supported on a rib, is movable between a retracted position above the circumferential edge and a deployed position below the circumferential edge. The earphone is also slidably supported to be vertically-adjustable. A telephone battery holder, positioned under the crown, is supported by the ribs. The holder has a convex shape that conforms to the ribs and to an inner upper portion of the crown. A microphone arm, pivotally supported on a rib, is movable to a deployed position and to a retracted position. Most of the arm is within boundaries defined by the concave underside of the visor when in the retracted position. The arm includes an approximately L-shaped proximal portion positioned adjacent the crown wherein the proximal portion enables the arm to get into said retracted position. When in the retracted position, a microphone is operatively positioned at the underside of the cap visor. A curved, arch-shaped antenna, supported by the visor, is positioned to conform to an arch-shaped and rounded frontal edge of the visor. A keyboard and liquid crystal display screen, positioned on the visor underside, are supported on a convex housing that is shaped to conform to the concave visor underside. In another preferred embodiment, a microphone is mounted near a leading edge of the visor underside and a telephonic earpiece is stored in an aperture in the visor.

### BRIEF DESCRIPTION OF THE DRAWINGS

The accompanying drawings in combination with the description herewith, illustrate features and advantages of the invention. Like reference numerals in different views refer to the same parts. The drawings are intended to illustrate principles of the invention and are not necessarily to scale.

FIG. 1 is a bottom view of a preferred wireless cap phone.

FIG. 2 is a fragmental side view, of the cap phone if FIG. 1, showing a housing with an attached telephone battery and arched ribs riveted to a convex back wall of the housing.

FIG. 3 is a fragmental side view, of the cap phone of FIG. 1, showing an earphone in retracted and deployed positions.

FIG. 4 is a fragmental side view, of the cap phone of FIG. 1, showing a microphone arm in retracted and deployed positions.

FIG. 5 is a fragmental side view of another preferred embodiment of a cap phone.

### DESCRIPTION OF PREFERRED EMBODIMENTS

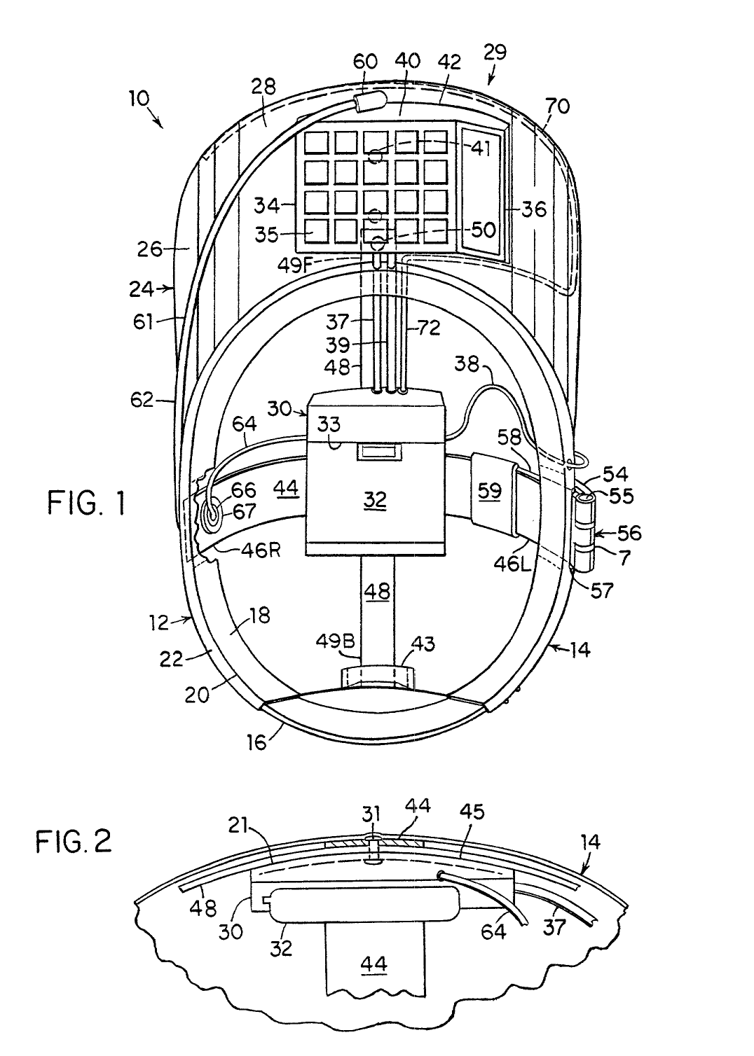

FIGS. 1-5 show preferred embodiments of the invention and illustrate principles thereof. Beginning with FIGS. 1-4, a preferred wireless cap phone 10 is shown. Included is a baseball-style soft cap 12 (FIG. 1) of mostly conventional construction and having a crown 14 comprising soft supple fabric. Cap 12 includes an adjustable strap 16 for adjusting the cap size and a sweatband 18. As is common practice in cap construction, a bottom edge portion 20 of sweatband 18 is attached to a circumferential edge portion 22 of crown 14 by stitching (stitches are not shown).

A stiff visor 24 is attached to a frontal edge of crown 14 by conventional means (such as stitching) wherein visor 24 projects from crown 14 in customary fashion for a baseball-style cap. Visor 24 has a conventional stiff plastic core (not shown) sandwiched between layers of fabric 26. Typical for a baseball-style cap, visor 24 is arch-shaped so that the visor underside 28 is concave.

Within crown 14, crossing the middle thereof, is a stiff arcuate first rib 44 made of plastic that forms an upstanding arch under crown 14. Lower end portions 46L, 46R, of rib 44 are positioned at diametrically opposite sides of crown 14 and are inserted between sweatband 18 and the fabric of crown 14.

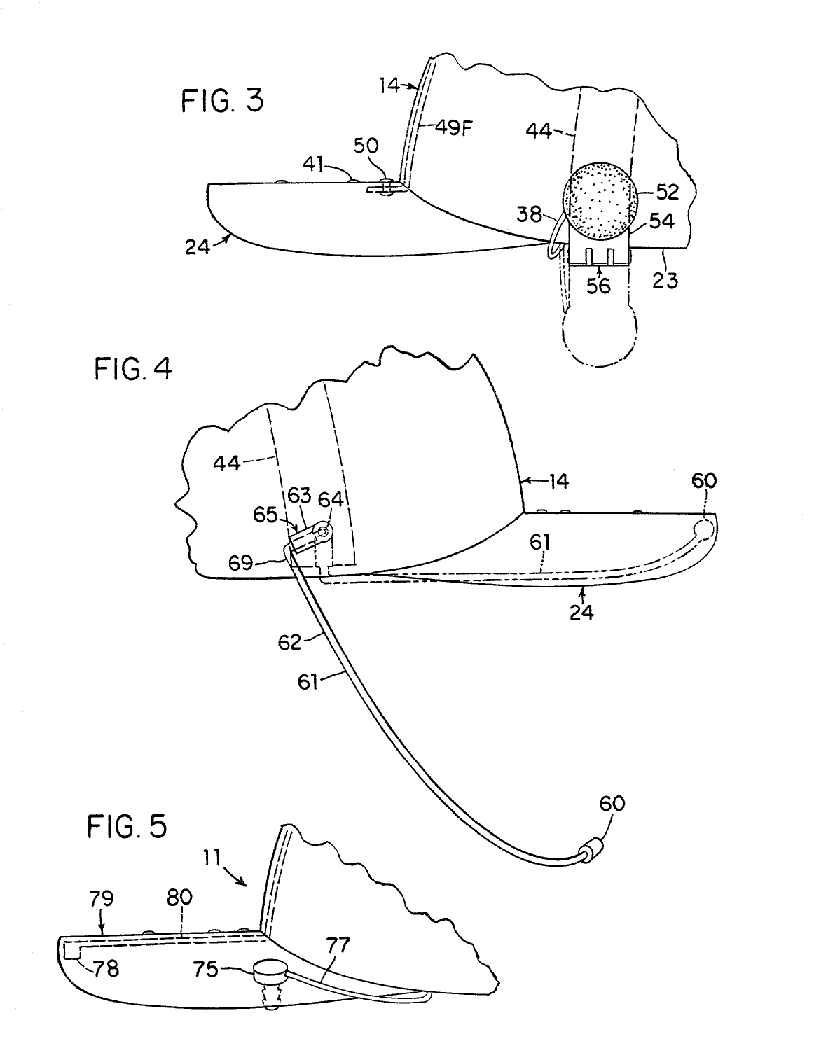

A second stiff plastic arcuate rib 48 forms another upstanding arch under and within crown 14. Rib 48 crosses rib 44 at right angles at the center of crown 14. A lower end portion 49F of rib 48 is positioned under sweatband 18 and under fabric 26. Rib end portion 49F is L-shaped (best seen in FIG. 3) wherein the open leg of the L is attached to a medial portion of visor 24 by a rivet 50. Thus, rib end portion 49F is rigidly fixed medially to visor 24. A diametrically opposite lower end portion 49B (FIG. 1) of rib 48 is positioned within a fabric pocket 43 sewn to the inside of a back or rear portion of crown 14.

Ribs 44, 48 line the inside of crown 14, thereby giving a nicely rounded appearance to the outside of crown 14.

A wireless telephone 29 is supported by cap 12 such that a user can communicate, with his or her hands free, by wearing and using cap phone 10. Telephone 29 comprises components positioned and supported in various locations of cap 12. Included is a plastic housing 30 containing conventional wireless telephone electronics (not shown) and a rechargeable telephone battery 32 operatively connected to the electronics for energizing telephone 29. Battery 32 is removable for recharging and can be reattached through an opening 33 so that housing 30 is also a battery holder. Attachment of battery 32 in housing 30 and electrical connection of the battery terminals (not shown) to the electronics is provided by conventional means commonly used in wireless telephones. The electronics are of the type having features commonly found in wireless telephones.

Ribs 44, 48 support housing 30 by way of a rivet 31 (FIG. 2) that passes through both ribs and though a back wall 45 of housing 30. A back portion 21 of housing 30 is curved in a convex shape that conforms to ribs 44 and 48 and to an upper inside portion of crown 14.

Another portion of telephone 29 includes a conventional keypad 34 (FIG. 1) having keys 35 for keying information to operate telephone 29. Also included is a conventional LCD display screen 36 provided for showing the user's entries and other information typically displayed by wireless telephones. Display screen 36 and keypad 34 are supported by a housing 40 having a back wall riveted to visor 24 with rivets 41. Electrical and other components (not shown) of display screen 36 and keypad 34 are conventional and are housed in housing 40. A back portion 42 of housing 40 is curved in a convex shape that conforms to the concave underside 28 of visor 24. Display screen 36, supported on housing 40, is pitched at an angle relative to keypad 34 for easy viewing of the display. Electrical communication between the electrical components contained in housings 30 and 40 is through conventional electrical cords 37 and 39 which pass out of apertures in housings 30 and 40, and under sweatband 18, and through openings in edge portion 22. All electrical circuits (not shown), in housings 30 and 40 and connected by cords 37 and 39, are conventional.

Supported on rib 44 is a conventional earpiece or earphone 52 (FIG. 3) which has a back side cemented to an outer leaf 54 of a plastic hinge 56. An inner leaf 58 (FIG. 1) of hinge 56 passes through an open slit 57 in edge portion 22. Leaf 58 is positioned between rib 44 and crown 14. A hinge pin 55 pivotally connects leaves 54 and 58. Thus, as shown in FIG. 3, earphone 52 can pivot between a retracted position adjacent crown 14 and above a circumferential edge 23, and a deployed position (shown in phantom image) below circumferential edge 23.

Leaf 58 is integrally connected to a narrow sleeve 59 (FIG. 1) that surrounds rib 44 and is slidable up and down thereon. Hence, hinge 56 and earphone 52 are slidably supported on rib 44 for vertical (up and down) adjustments of earphone 52. A user or wearer of cap phone 10, therefore, can make adjustments of earphone 52 to selective positions when in the deployed position. Rubber washers 7, surrounding pin 55 and compressed between leaves 54 and 58, create sufficient friction to maintain earphone 52 in the retracted or deployed positions as placed by the user.

Electrical communication between earphone 52 and the telephone electronics is by an earphone cord 38 operatively connected to the electronics in conventional manner. Cord 38 passes out of an aperture (not shown) in housing 30, then under sweatband 18 and through an opening in edge portion 22, and is operatively connected to earphone 52.

Supported on end portion 46R of rib 44 is a microphone boom or microphone arm 61 (FIGS. 1 and 4) having a conventional microphone 60 attached to a distal end portion thereof Arm 61 comprises a curved hollow plastic tube 62 with a microphone cord 64 (FIG. 1) passing through tube 62. An L-shaped proximal end portion 69 (FIG. 4) of arm 61 is press-fitted or cemented in a first end portion 63 of a hollow plastic elbow 65 having a right-angled bend. A second end portion 66 (FIG. 1) of elbow 65 is pivotally received in an aperture passing through crown 14 and through rib 44. The open end of elbow portion 66 is press-fitted or cemented in a plastic washer-shaped flange 67. Hence, microphone arm 61 with its microphone 60, elbow 65, and flange 67 are pivotally supported on rib 44.

As described and shown in the figures, arm 61 is positioned and shaped so that most of arm 61 fits substantially hidden within boundaries defined by concave underside 28 of visor 24 when moved to a retracted position (phantom image of FIG. 4). The L-shaped proximal portion 69, adjacent crown 14, enables arm 61 to get into the retracted position. Arm 61 is also movable to optional deployed positions, including those indicated by the solid line images of FIGS. 1 and 4, depending on where the wearer or user prefers to position arm 61. Microphone 60 has advantages in the deployed and retracted positions because it is within voice range of the wearer, even when positioned at visor 24. In the retracted position, concave visor 24 acts like a large ear by focusing the sound of the wearer's voice into microphone 60.

Microphone cord 64 is operatively connected to microphone 60 and extends along the inside of tube 62 and through hollow elbow 65. Cord 64 then passes through an aperture in housing 30 and is operatively connected to the telephone electronics in conventional manner (not shown).

Shown in FIG. 1 is an antenna 70 sandwiched under visor fabric 26. Antenna 70 is curved and positioned at a frontal edge of visor 24 to conform to the arch-shaped concave visor underside 28 and to the rounded frontal edge of visor 24. Antenna 70 communicates with the telephone electronics by a wire 72 that runs from antenna 70, under fabric 26, then under sweatband 18 and through an aperture in housing 30. Antenna wire 72 is operatively connected to the electronics in conventional manner.

Another preferred embodiment of the invention is cap phone 11 shown in FIG. 5. All components of cap phone 11 are the same as those of cap phone 10, except that earphone 52, hinge 56, sleeve 59, arm 61, microphone 60, and elbow 65 are not present in cap phone 11. Replacing earphone 52 is a conventional telephonic earpiece 75 of the type that can be inserted in the user's ear. When not in use, earpiece 75 can be stored in cap visor 79 (as shown) by being received in an aperture passing through cap visor 79. An earphone cord 77 operatively connects earpiece 75 with the telephone electronics.

Replacing arm 61 and microphone 60 in cap phone 11 is a conventional surface mountable microphone 78 cemented to a concave underside of visor 79 near the leading edge thereof. Microphone 78 is hidden within boundaries defined by the concave underside of visor 79 and is sheltered thereunder. Concave visor 79 acts like a large ear by focusing the sound of the wearer's voice into microphone 78. A microphone cord 80 connects microphone 78 to the telephone electronics.

Ramifications and Scope

Although the above description contains many specificities, these should not be construed as limitations on the scope of the invention, but rather as exemplifications of preferred embodiments. Many other variations are possible. For example, earphone 52 and hinge 56 could be replaced by an “over-the-ear” earpiece or by an “in-the-ear” earpiece. Arm 61 could be replaced by an adjustable gooseneck microphone boom. Keypad 34 and display screen 36 could be oriented 90 degrees to the present position under the visor. Or, a keypad and/or display screen could be supported under a cap crown by one or more arcuate ribs. A battery holder could be supported by one arcuate rib rather than two. Thus, the scope of the invention should be determined not by the given examples, but by the appended claims and their legal equivalents.

What is claimed is:

1. A cap phone comprising:
a cap including a soft crown and a visor attached to the crown; and
a telephone supported by the cap such that a user can telecommunicate, hands-free, while wearing the cap.

2. The cap phone of claim 1, wherein the crown includes a circumferential edge and the telephone includes an earphone movably supported to move between a retracted position above the circumferential edge and a deployed position below the circumferential edge.

3. The cap phone of claim 2, wherein the earphone is pivotally supported to move between said retracted and deployed positions.

4. The cap phone of claim 2, wherein the earphone is slidably supported to be vertically-adjustable.

5. The cap phone of claim 1, wherein a substantial portion of the telephone including a telephone battery holder is supported under the crown.

6. The cap phone of claim 1, wherein a telephone battery holder is positioned under the crown, the holder having a convex shape that conforms to an inner upper portion of the crown.

7. The cap phone of claim 1, wherein the visor includes a concave underside and the cap phone includes a movably supported microphone arm, the arm being movable to a deployed position and to a retracted position wherein most of the arm is within boundaries defined by the concave underside of the visor when in the retracted position.

8. The cap phone of claim 7, wherein the arm includes a proximal portion positioned adjacent the crown, the proximal portion being approximately L-shaped to enable the arm to get into said retracted position.

9. The cap phone of claim 1, wherein the visor is arch-shaped and the telephone includes an antenna supported by the visor, the antenna being arch-shaped thereby conforming to the visor.

10. The cap phone of claim 1, wherein the visor includes a rounded frontal edge and the telephone includes an antenna supported by the visor, the antenna being shaped and positioned to conform to the rounded frontal edge of the visor.

11. A cap phone comprising:
a cap including a crown and a visor attached to the crown, the visor having an underside; and
a telephone supported by the cap, the telephone having a keypad positioned on the visor underside.

12. The cap phone of claim 11, wherein said underside is concave and the keypad is supported on a convex housing shaped to conform to the concave visor underside.

13. The cap phone of claim 11, further comprising the telephone having a display screen supported on the visor underside.

14. The cap phone of claim 13, wherein said underside is concave and the display screen is supported on a convex housing shaped to conform to the concave visor underside.

15. A cap phone comprising:
a cap including a soft crown and a visor attached to the crown; and
a telephone combined with the cap such that a user can telecommunicate while wearing the cap, the telephone being a least partially supported by a stiff arcuate rib that forms an upstanding arch under the crown.

16. The cap phone of claim 15, wherein the telephone includes a microphone arm movably supported by the rib.

17. The cap phone of claim 16, wherein the visor includes a concave underside and the arm includes a proximal portion positioned adjacent the crown, the proximal portion being approximately L-shaped to enable the arm to get into a retracted position wherein most of the arm is within boundaries defined by said concave underside.

18. The cap phone of claim 15, further comprising a second stiff arcuate rib that forms an upstanding arch under the crown for additional support of the telephone, the second rib having an end portion fixedly connected to the visor wherein the ribs are transverse to each other.

19. The cap phone of claim 15, wherein a telephone battery holder is positioned under the crown, the holder being supported by the rib, the rib having an end portion rigidly connected to the visor.

20. The cap phone of claim 1, wherein a microphone is operatively positioned at the cap visor.
